(19) United States
(12) Patent Application Publication
(10) Pub. No.: US 2010/0250290 A1
(43) Pub. Date: Sep. 30, 2010

(54) SYSTEM AND METHOD FOR TOKEN-BASED TRANSACTIONS

(75) Inventors: Howard Lefkowitz, Henderson, NV (US); Bradley Roy More, Naples, FL (US)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: VEGAS.COM, Henderson, NV (US)

(21) Appl. No.: 12/413,321

(22) Filed: Mar. 27, 2009

(51) Int. Cl. G06Q 20/00; G06Q 40/00; G06Q 10/00; G06Q 30/00; G06F 17/00

(52) U.S. Cl. 705/5; 705/41; 705/17; 235/375

(57) ABSTRACT

A computer system enables creation of tokens and token-based transactions with participating point-of-sale vendors. User information, revenue source information, and reservation information corresponding to a physical property are compiled and processed to generate a token code. The token code uniquely corresponds to the user and is associated with a revenue source and the reservation information. The token code is disposed on a tangible token object to create a token suitable for transaction.

### TECHNICAL FIELD

The disclosure relates to transaction systems employing apparatuses for identifying users and corresponding revenue sources.

### BRIEF DESCRIPTION OF THE DRAWINGS

The various aspects and advantages are described by way of example in the following description of several embodiments and attached drawings. It should be understood that the accompanying drawings depict only typical embodiments and, as such, should not to be considered to limit the scope of the claims. The embodiments will be described and explained with specificity and detail in reference to the accompanying drawings in which:

FIG. 1 is a block diagram of an embodiment of a system to purchase and reserve event services.

FIG. 2 is a block diagram illustrating potential points-of-sale (POS) interfacing, both directly and indirectly, with a system.

FIG. 3 is a block diagram illustrating an embodiment of a system for token-based transactions.

FIG. 4 is a block diagram illustrating an embodiment of a system for token-based transactions.

FIG. 5 is a flow diagram of one embodiment of a method performed in creating a token for token-based transactions.

### DETAILED DESCRIPTION OF PREFERRED EMBODIMENTS

Embodiments of a method for reserving and purchasing events are described herein. In the following description, numerous details are provided to give a thorough understanding of embodiments. One skilled in the relevant art will recognize, however, that the embodiments can be practiced without one or more of the specific details, or with other methods, components, materials, etc. In other instances, well-known structures, materials, or operations are not shown or described in detail, to avoid obscuring innovative aspects of this disclosure.

Reference throughout this specification to “one embodiment” or “an embodiment” means that a particular feature, structure, or characteristic, described in connection with the embodiment, is included in at least one embodiment. Thus, the appearances of the phrases “in one embodiment” or “in an embodiment” in various places throughout this specification are not necessarily all referring to the same embodiment. In particular, an “embodiment” may be a system, an article of manufacture (such as a computer-readable medium), a method, and a product of a process.

For convenience, reference is also made to users and customers, which are “human parties” or “humans,” to distinguish them from computer and software operations. Operation of a computer and software may be overseen by human administrators and driven by data and/or commands from human users.

Suitable networks for configuration and/or use, as described here, include one or more local area networks, wide area networks, metropolitan area networks, and/or “Internet” or IP networks, such as the World Wide Web, a private Internet, a secure Internet, a value-added network, a virtual private network, an extranet, an intranet, or even standalone machines, which communicate with other machines by physical transport of media (a so-called “sneakernet”). In particular, a suitable network may be formed from parts or entireties of two or more other networks, including networks using disparate hardware and network communication technologies.

One suitable network includes a server and several clients; other suitable networks may contain other combinations of servers, clients, and/or peer-to-peer nodes, and a given computer may function both as a client and as a server. Each network includes at least two computers, such as the server and/or clients. A computer may be a workstation, laptop computer, disconnectable mobile computer, server, mainframe, cluster, so-called “network computer” or “thin client”, personal digital assistant or other hand-held computing device, “smart” consumer electronics device or appliance, or a combination thereof.

Each computer includes at least a processor and a memory; computers may also include various input devices and/or output devices. The processor may include a special purpose processing device, such as an ASIC, PAL, PLA, PLD, Field Programmable Gate Array, or other customized or programmable device. The memory may include static RAM, dynamic RAM, flash memory, ROM, CD-ROM, disk, tape, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The network may include communications or networking software, such as the software available from Novell, Microsoft, Artisoft, and other vendors, and may operate using TCP/IP, SPX, IPX, and other protocols over twisted pair, coaxial, or optical fiber cables, telephone lines, satellites, microwave relays, modulated AC power lines, physical media transfer, and/or other data transmission “wires” known to those of skill in the art. The network may encompass smaller networks and/or be connectable to other networks through a gateway or similar mechanism.

At least one of the computers is capable of using a floppy drive, tape drive, optical drive, magneto-optical drive, or other means to read a storage medium. A suitable storage medium is a computer-readable storage medium, including a magnetic, optical, or other computer-readable storage device having a specific physical configuration. Suitable storage devices include: floppy disks, hard disks, tape, CD-ROMs, DVDs, PROMs, random access memory, flash memory, and other computer system storage devices. The physical configuration represents data and instructions, which cause the computer system to operate in a specific and predefined manner, as described herein. Thus, the medium tangibly embodies a program, functions, and/or instructions that are executable by computer(s) to reserve and purchase events, as described herein.

Suitable software to assist in implementation is readily provided by those of skill in the pertinent art(s) using the teachings presented here and programming languages and tools, such as Java, Pascal, C++, C, XML, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Several aspects of the embodiments described will be illustrated as software modules or components. As used herein, a software module or component may include any type of computer instruction or computer executable code located within a memory device. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Much of the infrastructure that can be used is already available, such as: general purpose computers, computer programming tools and techniques, computer networks and networking technologies, digital storage media, authentication, access control, and other security tools and techniques provided by public keys, encryption, firewalls, and/or other means, bank transfers, credit card processing, digital money, and other tools and techniques for making payments.

An event may be any activity contemplating the participation and personal attendance of a human. An event may require an advanced request to attend. Attendance requires a person to go to a designated location. An event may not require an advance reservation, such as attending a theme park or museum, but may nevertheless require a ticket. In many, but not all instances, event attendance may require a ticket and often such a ticket is obtained only by purchase. Other events may not cost anything to attend, but may have limited space, so attendance merely requires making an advanced reservation of the limited space. Although advanced reservation to attend an event may in some cases be free, making a reservation can still be considered a purchase because even a purchase of $0.00 costs the customer time in scheduling to attend the event and time and effort spent in obtaining the reservation.

Some events are user-attended perishable events, wherein the event has an established date, time, and duration and, thus, can only be attended during that block of time. Any portion of the pre-established time during which the user is not attending the event perishes; the opportunity to attend that portion of the event has passed, and a corresponding portion of the purchase is wasted. Whether an event is perishable may be important for customers who prefer to not allow purchases to be wasted by passing unattended. Types of events may include, but are not limited to: accommodations, shows, sporting events, transportation, dining reservations, museums, tours, amusement parks, and other activities and attractions.

An accommodation event may include, but is not limited to: hotel rooms, apartment rentals, house rentals, timeshare rooms, houseboat rentals, and the like. Thus, the term accommodation includes a variety of embodiments where a customer may reside temporarily for travel. An accommodation event typically requires check-in and check-out dates, but the time of check-in and check-out is often flexible. An accommodation may also be available after the day of check-in, but a customer may have lost a portion of the event. Thus, the accommodation event may be considered perishable in that reserved days expire, and a customer/guest needs to be present on the reserved days in order to enjoy the accommodation. The accommodation may also be extended based on availability and at the discretion of the event provider.

A show event may refer to a theater show of many different varieties, including but not limited to a movie, ballet, opera, play, or a concert. A show may also refer to a show somewhere other than a theater, such as a stadium or an arena. Such shows may include, but are not limited to a circus, a fireworks display, or a show on ice (such as Disney® on Ice). A show event may include a specific date and time. The show event may also include one or more specific seats, or the show event may have open seating. As the show event occurs at a specific date and time, the show event is perishable in that the customer must be physically present at the date and time in order to enjoy the event.

A sporting event may include viewing of sporting events of many different varieties, including but not limited to: a football game, baseball game, basketball game, hockey match, tennis match, motor cross, golf tournament, horse racing, and the like. A sporting event may include a specific date and time. The sporting event may also include one or more specific seats, or the sporting event may have open seating. As the sporting event occurs at a specific date and time, the sporting event is perishable in that the customer must be physically present at the date and time in order to enjoy the event.

A dining event may include, but is not limited to: a reservation at a restaurant. A dining reservation typically includes a specific date and time and is also perishable. If a customer arrives too late, the dining reservation may be cancelled, and lack of availability may preclude a customer from enjoying the dining event.

A transportation event may include, but is not limited to: airline reservations, bus tickets, train tickets, a cab ride, limousine rental, car rental, horse carriage ride, and the like. A transportation event that allows for an advanced reservation may generally be perishable in that such event requires meeting the carrier at a predetermined pick-up location at a pre-determined time. If the time for pick-up passes, the event perishes. Other transportation events may not be perishable, such as a pass to ride on a local bus system, subway, or other transit system, or a voucher for a cab ride from a particular company.

An activity event may require participation by the person attending the event and may or may not be a perishable event. Certain activities may be perishable based on the event and the event provider. For example, certain tours, skydiving, golf, river rafting, guided fishing trips, guided hunting expeditions, and the like may require specific dates and times in order to accommodate customers. Such events may be perishable. Other activity events may not require specific times and dates, such as amusement parks, water parks, theme parks, museums, ski resorts, summer resorts, zoological parks, state and national parks, water parks, and clubs. Such activity events may be open generally to the public, and thus, may not be perishable. Such events are not perishable if tickets to (or at least reservations to attend) the event may be useable at any time and on any date (or at least within a fairly wide range of dates) at the customer's convenience.

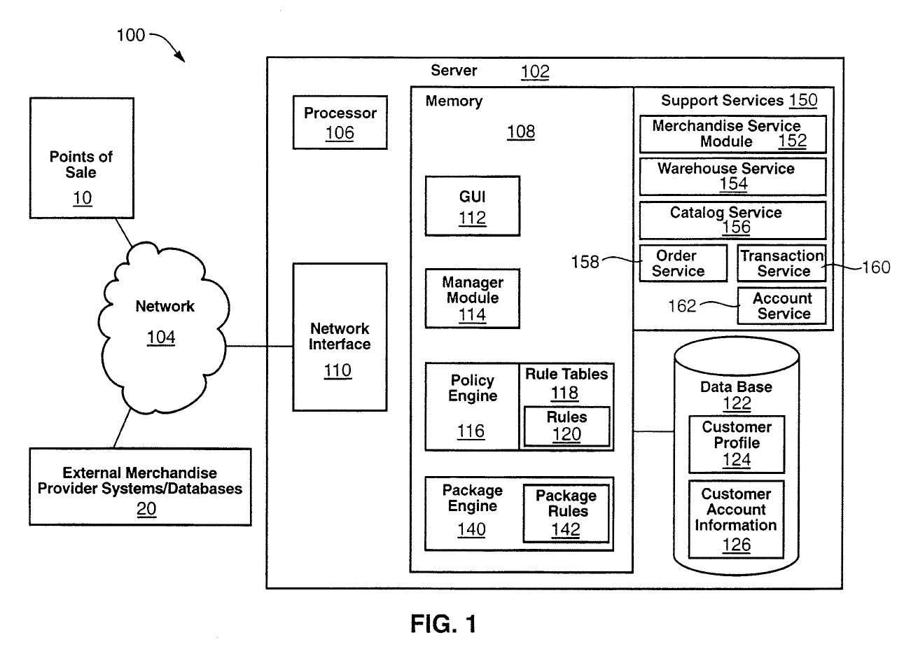

Shown in FIG. 1 is a block diagram of one embodiment of a reservation and purchase system 100. The system 100 may include a server 102 or computer accessible through a network 104, such as the networks described above. The server 102 may include a processor 106 and a memory 108 having stored thereon computer readable instructions and modules to perform the teachings described herein.

Points of sale (hereinafter “POS”) 10 may interface with the system 100 through the network 104 to reserve and purchase events. The system 100 may also interface with external merchandise provider systems 20. A merchandise provider system 20 may comprise one or more servers and one or more databases to provide information on various events.

The system 100 may comprise a network interface 110 to enable communication with the network. The system 100 may also comprise a graphical user interface (GUI) 112 to enable and facilitate selection and purchase of events. The GUI 112 may be resident in the memory 108 and may be embodied in various formats, such as being compatible with conventional web browsers. The GUI 112 may include various menus and options to allow a user to navigate through a variety of events. As can be appreciated, the number of events and options may be significant and providing a user-friendly interface greatly improves a reservation experience.

The system 100 may comprise a manager module 114 resident in the memory 108, which oversees operations and calls upon the various applications and modules as needed to enable event purchase and reservation. The system 100 may comprise a policy engine 116, resident in memory 108, which determines the events that will be viewable through the GUI 112 and available for purchase and reservation. The policy engine 116 may further determine how and in what order events are displayed to a user. The policy engine 116 may make these determinations based on various factors, such as event inventory, the POS, and the customer profile.

The policy engine 116 may include one or more rule tables 118, comprising rules 120, which are used to determine which events are available and how the events are displayed. The policy engine 116 applies rules 120 from the various tables 118, which affects which events may be displayed, reserved, and purchased. A common rule is simply event availability. As events are time-constrained products, they may be sold out for a given date and time. Thus, when a hotel is completely booked for requested dates, a lodging event at the hotel for those dates is not available for purchase.

The rule application may depend on a variety of factors, including the POS 10 and the customer profile. Thus, some of the rules 120 of policy engine 116 may be pre-defined according to the POS 10, such as the location or the affiliation of the POS 10. A POS 10 may be a resort or hotel, which is offering one or more specific events. As can be appreciated, the resort may wish to offer only their events or may wish to display their events in a preferential manner. Certain events may also be more profitable than other events, and the more profitable events may be displayed in a preferential manner.

Preference may be given to events by listing certain events first, highlighting events, and the like. Thus, a rule 120 may require that events specific to a POS 10 be viewed or listed preferentially when that POS 10 accesses the system 100. Rules 120 regarding a customer profile may require consideration of entertainment preferences/restrictions, the customer's previously attended events, the customer's wish list, dietary preferences, customer physical limitations, and the like.

The system 100 may include one or more databases 122, which store customer profiles 124 comprising data specific to a customer. A customer profile 124 may include enduring data, which remains a part of the customer's profile until changed. Enduring data may include, but is not limited to, address, physical constraints, dietary restrictions, previously attended events, and preferences. The customer profile 124 may also include transient data which is applicable only for a particular query or session of queries. Transient data may include, but is not limited to, customer availability, customer location, desired number of events, pricing restrictions, number in party, and the like.

When a user or customer accesses the system 100 from a POS 10, the manager module 114 and GUI 112 may prompt for a login or other customer identification. The system 100 may be configured to establish customer accounts with user names and passwords. Each customer account may be associated with a customer profile 124 stored in the database 122. Thus, when logging in, the system 100 is able to retrieve a customer profile 124. Furthermore, additional customer account information 126 may be stored in the database 122, such as billing information, correspondence and contact information, and the like. As such information is highly confidential, the necessary encryption may be employed for security.

The system 100 may retrieve a customer profile 124 and customer account information 126 whether the customer logs in from a POS 10 or a user logs in on behalf of a customer from a POS 10. Logging in on behalf of a customer may occur in resorts, hotels, call centers, and the like. The manager module 114 may activate the policy engine 116 and apply certain rules 120 based on the customer profile 124. For example, if the customer is in a certain income bracket, the rules 120 may dictate that certain events be listed or otherwise viewed preferentially. If a customer has a modest income, then the rules 120 may require that preference be given to economical events. More expensive events may also be listed, but may be further down on a list, displayed on subsequent web pages, or viewed in some other non-preferential manner. A customer with a high income may have higher priced events listed or viewed preferentially. In another example, the rules 120 may dictate that customers in certain age brackets have events listed or viewed preferentially. Physically demanding events may be listed or viewed with less preference for senior citizens. Alcohol related events, such as wine tasting, may be listed or viewed with less preference for an under-age customer. The rules 120 may also dictate preference based on a customer's past purchases. If a customer often stays at a certain hotel and dines at a specific restaurant and frequently plays golf, then these corresponding event options may be displayed with preference. As can be appreciated, the rules 120 may apply any of the data in a customer profile 124 in providing preferential display. In one embodiment, certain events which are unlikely to be selected may not be available and not listed to facilitate navigation by reducing options. A customer profile 124 may indicate a certain membership, loyalty program status, benefits, or privilege that allows access to exclusive events, upgrades, promotions, and the like. For example, a customer may have membership in a dining club, country club, travel lounge, hotel, airline, travel agency, and the like. By virtue of such membership, a customer may be able to participate in events that are not available to the general public. In another example, a customer profile 124 may indicate that a customer is a VIP or a “high roller,” i.e., a high stakes gambler. This customer may be able to participate in gaming events in a casino which are not available to the general public. The customer profile 124 may be accessed and viewed by travel agents, airlines, hotels, and the like to provide travel related services and benefits for a customer.

Furthermore, the policy engine 116 may apply rules 120 based on a customer status to determine event availability. A customer status may be stored in a customer profile. The higher the customer status, the more events that may be available for display and purchase. Customer status may depend on the number of customer purchases, such as a loyalty program. Customer status may also be indicated by a unique indication in a profile 124 that a customer is a VIP.

As can be appreciated, the rules 120 reflecting event viewing and selecting may be modified as desired based on any data in customer profile.

The system 100 allows the purchase and reservation of single and multiple events, and may further provide an event package. An event package includes multiple events, which are compiled by a package engine 140 to reduce user involvement in event planning. Thus, a user need not select each event, but can consider purchasing an event package. The package engine 140 attempts to provide a customized package that satisfies a user's expectations and preferences. The GUI 112 may provide an option to initiate the package engine 140.

The package engine 140 may present questions in a wizard-style user interface to be answered by the customer. The package engine 140 may gather information by presenting simple questions, or may be a more involved narrative, explaining in greater depth the significance of questions being asked and preferences that may be provided. The package engine 140 may inquire as to arrival and departure times, entertainment preferences, dining preferences, preference for the pace of a schedule, and the like. In addition to asking questions, the package engine 140 may also rely on data in a customer profile 124, if available. Thus, the customer profile 124 may supplement the customer responses.

In one embodiment, the package engine 140 may employ a software wizard to provide a questionnaire. The questionnaire prompts a user with different questions and/or preferences. Prompts for preferences may provide a scale to rank preferences and a user responds with answers and preferences. The package engine 140 may assign a weight to each answer and preference to determine suitable events, such as accommodations, shows, tours, dining, transportation and other options. In completing responses relating to accommodations, a user may indicate price preferences, geographic preferences, amenity preferences, date preferences, occupancy preferences, and the like. These preferences may be weighted by the package engine 140 and considered in selecting an accommodation. Events are searched to generate matches to the customer based on the responses. The events may then be compiled into an event package to provide a group of events for purchase.

The entering of answers and preferences may be done on behalf of a customer. For example, a hotel concierge may enter answers and preferences while assisting a hotel guest.

The package engine 140 considers responses and may apply package rules 142 or rules 120 to generate one or more event packages. A package rule 142 may require that an event package include one or more types of events. For example, a package rule 142 may require selection of an accommodation, selection of at least one show, selection of at least one dining reservation, selection of two activities, etc. Package rules 142 may require certain anticipated needs, such as transportation to and from an accommodation.

Package rules 142 may determine that by selecting other events, such as a show, activity, or dining, the location of these events may influence the selection of an accommodation. Package rules 142 may dictate that an accommodation be weighted more favorably if it is located in the vicinity of one or more other activities. Likewise, other events may be weighted more favorably if they are in the vicinity of each other. For example, a dining reservation for a restaurant next door to the hotel may be weighted more favorably than a dining reservation for a restaurant several miles from the hotel. However, based on responses in a questionnaire, a dining reservation may nevertheless be weighted with a strong enough preference to overcome a geographical weighting preference.

Package rules 142 may also require selection of events from certain providers. Selection of certain provider events may be based on the POS. As can be appreciated by one of skill in the art, package rules may be established to accommodate a variety of preferences in order to please customers and event providers.

In addition to weighting preferences, the package engine 140 may confirm that the events are conveniently located to one another. Furthermore, the package engine 140 may confirm that any potentially conflicting events are co-available in that they do not overlap in time. An accommodation would not be a conflicting event with a show, dining reservation, or activity. Furthermore, the package engine 140 may confirm that the events are appropriately co-related in that there is sufficient travel time between each event.

Rather than presenting a user with options for a single event, the user is presented with an event package. The package engine 140 attempts to generate an event package that is acceptable and pleasing to the customer. The event package may be presented for purchase with a total price. The event package may be listed or viewed with other event packages for user review and comparison. Thus, the package engine 140 may provide alternative event packages in an attempt to meet a customer's expectations.

The package engine 140 may return with an event package, including events selected from different event types. Each event may be favorably weighted based on the user-entered responses. A resulting event package is displayed to a user for review and possible purchase. The package engine 140 may also display a plurality of event packages, and these event packages may be ranked according to favorable matching. A user may review the event packages and manually select a preferred event package. The package may include a single price to facilitate the transaction.

An event package may also be customized based on user preferences. In one embodiment, a customer or user may deselect events, add events, or otherwise modify an event package. Thus, the event package may be considered an initial proposal of events. Selection of additional events may be performed according to the teachings disclosed herein. Accordingly, a user may be able to change one or more events. For example, if a user does not wish to attend a show, a user may deselect the show, select an alternative show, and/or request a search for an alternative show. If a user wishes to select an alternative show, the user may be directed to a listing or grouping of alternative shows that are available at approximately the same time.

By way of example, a customer may initiate the package engine 140 and indicate interest in an event package, event, or other desired action for Las Vegas. The package engine 140 may prompt for arrival and departure times and provide a questionnaire reflecting interests and preferences. The package engine 140 may then automatically generate an events package which includes lodging within the arrival and departure times, shuttles, dining reservations, show reservations, tours, free time for gaming, and the like. As used herein, the term automatically means without user intervention. Thus, although a user may initiate the package engine 140 and complete a questionnaire, the package engine 140 generates the events package. If the customer is pleased with the events package, the customer may purchase the package or perhaps modify the package if this feature is available. The package engine 140 may also generate an event package in response to customer selection of one or more events or by indicating an interest in one or more events. The package engine 140 may be configured to automatically generate one or more proposed event packages in response to any desired customer input.

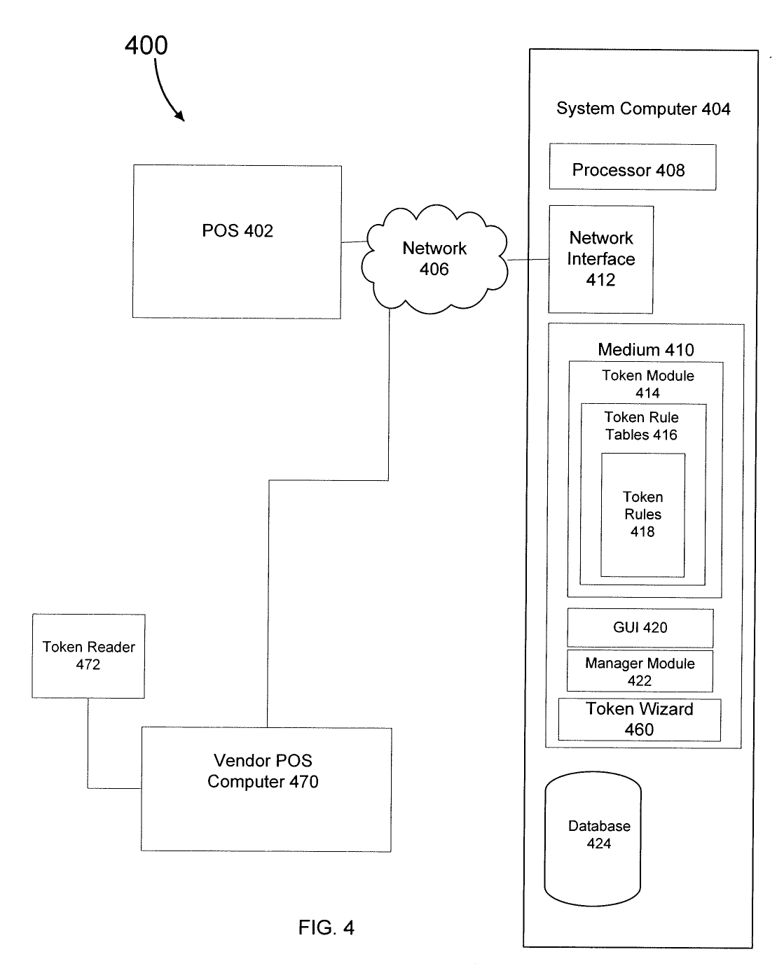

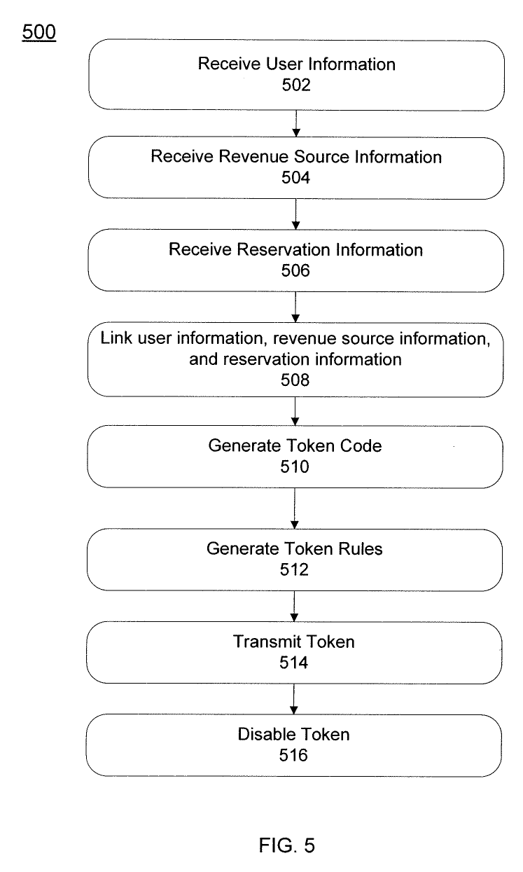

The manager module 114 may operate in communication with one or more support services 150. Support services 150 may be embodied as computer readable modules capable of performing unique assistance to the manager module 114 in offering events for sale. The support services 150 may include a merchandise service module 152 which determines the convenience and practicality of traveling between multiple events. In so doing, the merchandise service module 152 determines the co-relation and co-availability of events. This is discussed in further detail below in relation to FIGS. 4 and 5.

The support services 150 may further include a warehouse service 154, which maintains a directory of events, for purchase and reservation, that are accessible through an external provider. An external provider may maintain a warehouse which stores event inventories. The warehouse service 154 provides an interface with the external provider and warehouse to access events for purchase and reservation.

The catalog service 156 provides a description of one or more events. By selecting an event and requesting additional information, the catalog service 156 may provide the requested information.

An order service 158 provides an on-line virtual “shopping cart” to hold individually selected events or a package including a plurality of events. A transaction service 160 enables the purchase of events in the shopping cart through conventional methods, such as credit and debit cards, bank accounts, hotel folios, cash, and all other such forms of payment, as well as on-line accounts, such as PayPal.

The account service 162 enables the creation and management of customer accounts. Upon creation of an account, a password may be created to enable access to the account. The customer account may include billing, shipping, and correspondence information, all of which may be associated with a customer profile 124 unique to a customer. The customer account and associated information may be stored within a database 122.

The manager module 114 aggregates user behavior to note purchasing trends and behavior to thereby predict what the customer will buy. Information relating to prior purchases may be stored in a customer profile 124. The manager module 114 may organize events according to classes and display events to a customer based on a customer's purchasing behavior of events in the same class. Thus, if the customer has purchased magic show events, the merchandise engine may present magic show events. The manager module 114 may present the same magic show event purchased previously as well as alternative magic shows. As can be appreciated, live magic shows may be a class of events that appeal to a particular group of customers. The manager module 114 may also review purchasing patterns and/or a customer profile 124 and determine a customer class for a customer. The customer class may then be matched to events within a suitable class. A customer who typically purchases expensive live shows in Las Vegas would be matched to expensive live shows. Matched events are then displayed to a customer in a preferential manner. The system provides a result that will likely please the customer and the event providers.

The illustrated support services 120 is not an exhaustive list, and many additional services may be embodied to provide e-commerce functions.

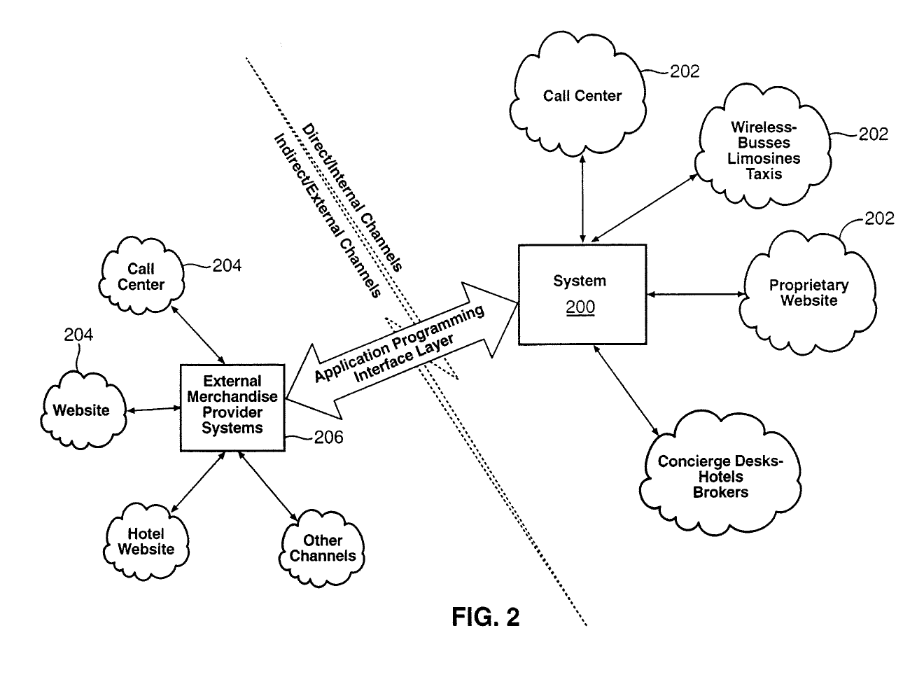

FIG. 2 illustrates a block diagram of a system 200 for purchasing and reserving events and the system's relation to various POS. FIG. 2 depicts direct, or internal, channels, wherein an internal POS 202 directly interfaces with the system 200. A POS 204 may also indirectly interface with the system 200 through indirect, or external, channels. A POS 204 may further interface with an external merchandise provider system 206 to purchase merchandise offered through the system 200 of the present disclosure. The POS 204 may also include unmanned and automated venues and locations, such as lockers, arcades, key locks, media devices, and the like.

A POS, as indicated in FIGS. 1 and 2, may be any one of a wide variety of interface devices that communicate with a system 200. Such interface devices may include, but are not limited to, a computer terminal, a telephone, or wireless device, such as a mobile phone, Blackberry, or a personal digital assistant (PDA). The interface device may be disposed at an interface location. An example of an interface location may include, but is not limited to a computer terminal accessing the system 200 via the Internet (e.g. world wide web). The computer terminal may be located at a concierge desk at a hotel, club, restaurant, recreational facility, or other venue. A computer terminal may also be located at an automated answering service or a call center with network access to the system. A computer terminal may also be located within a vehicle and configured with wireless communication. With a vehicle, a vehicle operator, such as a chauffeur, cab driver, or bus driver, may access the system via a cell phone or via a PDA or other wireless communication device to make reservations and purchases. Alternatively, an interface device may be fixed to the vehicle for use by various passengers. In this embodiment, the interface device may not be hand-held and would require mechanical disengagement to remove the interface device from a vehicle. In a call center, operators may operate a computer terminal to access the system 200 via a network, such as the Internet.

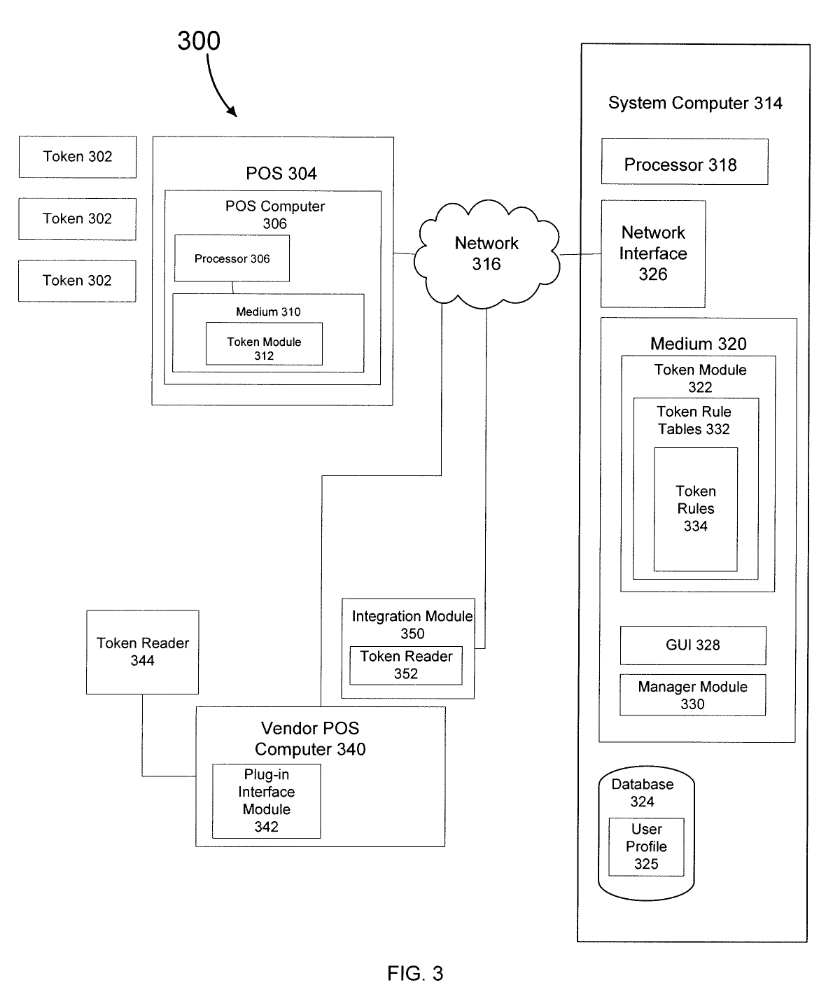

Referring to FIG. 3, a system 300 for transacting for goods and services with a token is shown. A token is generated in accordance with the teachings disclosed herein and uniquely identifies a user. As defined, a user is a participant in the system and may be a customer who wishes to purchase goods and services. The user may be affiliated with a vendor or other type of service provider in the system. For example, the user may be a guest at a resort, hotel or the like, a passenger on a cruise ship, and/or a participant in a travel package.

The token may be embodied in a variety of forms including as a tangible object with a human-readable or machine-readable unique token code. The token may be wearable by the user, such as a wristband, armband, necklace, or the like for convenience. For example, the token may comprise a token object with a token code formed, stamped, printed, or otherwise printed thereon for legibility by a token reader. The token object may comprise any durable and inexpensive material. In one example, the token may include a barcode, or other type of code, which is disposed on a wristband. By displaying the wristband, a token reader can identify a user account and conduct a transaction. The token may also be embodied as a radio frequency identification (RFID) tag, a unique password/user name, driver's license number, identification card, transaction card, and the like.

The token may also be embodied as a unique anatomical or physiological user biometric. For example, a user's fingerprint, eye characteristics, bone characteristics, heartbeat waveform, vein patterns, and the like may serve as a token provided that the biometric can serve to accurately identify the user. For further verification, a plurality of biometrics may be used as a token to confirm the identity of a user.

A token may be configured to function on a long-term basis, and indeed, may function in perpetuity. A token may also be configured to function on a short-term basis, for example, during a stay at a resort or during passage on a cruise ship. A token may also function for predetermined schedules of use. For example, a token may function while the corresponding user has access or visitation rights to a recreational facility.

In addition to uniquely identifying a user, a token may be connected to or associated with one or more revenue sources. Similarly, a series of tokens may be connected to one or more revenue sources. With a series of tokens, each token uniquely identifies an individual. A group of individuals, such as a family, may then use their corresponding tokens and access the same revenue sources. The revenue sources may include credit card accounts, debit card accounts, bank accounts, money market accounts, a monetary account coupled to a hotel room or ship cabin, hotel folio, or other forms of monetary credit or debit. A revenue source may also include a form of credit which is only recognized amongst participating vendors.

The revenue sources may be accessed in a priority order. For example, a credit card account may be charged before other revenue sources. If the credit card account reaches a limit, then a debit card account may be accessed. In this manner, alternative revenue sources may be used to increase available funds. As can be appreciated, any number of revenue sources may be utilized and prioritized in various ways to accommodate token use. A single revenue source may also be used if desired, and once the single revenue source is depleted, then no further funds are available.

One or more revenue sources may have funding limits which may be set by a provider of the revenue source, or which may be set by a system described herein. Thus, in one example, a hotel provider may have a maximum room charge, but the limit for token use may be set lower than the maximum room charge. Furthermore, each token may have a limit determined by the revenue source or have a limit corresponding to the token itself. For example, a family may have been issued a series of tokens that are linked to the same revenue source(s). A token issued to a parent may not have a token-specific spending limit. A first token issued to a teenager may have a first token-specific spending limit, and a second token issued to a child may have a second token-specific spending limit less than the first token-specific spending limit. Token-specific spending limits may be set by a user responsible and accountable for the revenue source. A system may also provide default or suggested token-specific spending limits for users that are minors or for users who are not accountable for the revenue source.

Token-specific limits may also be tied to physical locations, certain vendors, certain participating groups of vendors, time durations, and geographical limits. For example, a child may have no spending limit at a cafeteria but have a spending limit at retail stores. A child may also have a daily spending limit, and at the beginning of a new day, the spending limit is once again available in full. There may be a limit for vendors within a certain affiliation, franchise, or the like. Furthermore, incentives may be established for certain vendors or group of vendors. Incentive credits may be earned for transactions with certain vendors, and discounts may be applied to certain vendors. To provide incentives, a vendor may offer a wide variety of discount programs for token-based transactions.

One or more tokens 302 may be purchased, generated, and issued from any number of locations including customer computers, affiliated vendor or service provider computers, system-specific computers or terminals, or any computer device in communication with the system 300. In one implementation, shown by way of example, a token 302 may be issued at a point-of-sale (POS) 304. Although issued at the POS 304, the token 302 may have been previously purchased or partially transacted for through a computer device. The token 302 may have also been previously reserved through a computer device and purchased, in whole or in part, at a POS 304. As can be appreciated, token transaction, generation, and issuance may vary considerably based on preferred implementation, all of which are included within the scope of the present disclosure.

The POS 304 may include any number of service provider outlets including on-site providers at a hotel, cruise ship, resort, theme park, retail store, restaurant, or other type of vendor or service provider. The POS 304 may include a POS computer 306 comprising a processor 308, a computer readable storage medium 310, and a token module 312 resident within the computer readable storage medium. The token module 312 enables generation of a token uniquely identified to a user and further connected to one or more revenue sources. The token module 312 may be used, in whole or in part, to confirm the identification of a user and the credentials of the user to participate in the system 300. Credential confirmation includes the availability and legitimacy of one or more revenue sources which will be coupled to one or more tokens. The token module 312 may also be used to confirm reservations with a resort, theme park, hotel, cruise ship, and the like. The POS computer 306 may be in electrical communication with a system computer or central token server 314 for part of the processing involved with token generation and issuance. In an alternative embodiment, the POS 304 may include a terminal with limited processing capability and may substantially defer token generation and issuance to the system computer 314.

As illustrated, the POS computer 306 may be in electrical communication with a system computer 314, also referred to herein as a central token server, over a computer network 316 to enable token generation and issuance. The system computer 314 may include a processor 318, computer readable storage medium 320 with computer readable instructions and modules to perform the functions disclosed herein. Although shown as a single computer, the system computer 314 may also be embodied as different, distinct computers and servers in electrical communication with one another and having dispersed processing and memory functions.

The computer readable storage medium 320 may comprise a token module 322 to provide token generation functions. As can be appreciated, the token module 322 may be completely resident on the computer readable storage medium 320 or dispersed on different storage mediums within the system computer 314 or on other computers.

The system computer 314 may further include a database 324 or other like memory which includes reservation information and user information, such as a user profile 325. A user profile 325 may include enduring data which remains a part of the customer's profile until changed. Enduring data may include, but is not limited to, residential address, billing address, and billing information relating to one or more revenue sources. The user profile 325 may also include transient data which is applicable only for a particular query or session of queries. Transient data may include, but is not limited to, user travel date availability, desired travel options, pricing restrictions, number in party, and the like.

The system computer 314 may also comprise some or all of the components and modules disclosed above in reference to the server 102. Thus, the system computer 314 may comprise a network interface 326, a graphical user interface (GUI) 328 to enable user navigation through menu options in various formats, and a manager module 330 to control operations and call upon the various applications and modules as needed.

The token module 322 may include one or more token rule tables 332 comprising token rules 334 which are applied to a token 302 and determine token use. Token rules 334 may impact every aspect of token use including revenue sources, spending limits, token time use durations, where tokens 302 may be used, service provider incentives for token use, user incentives for token use, and the like. Token rules 334 may utilize a variety of factors including information on the location or the affiliation of a POS 304, the user profile, or the revenue sources.

Token rules may utilize a wide variety of information relating to a product or service to be purchased, such as a SKU, demographics of customers typically purchasing such products or services, or access levels for a customer. Customer access levels may be based on information in a user's profile, such as membership in a program, customer age, and the like. In one example, a token rule may prevent token use by a minor for adult-oriented products or services. The nature of the products and services may be determined by the product or service SKU, known customer demographics, or even customer access levels. In another example, a non-member of a country club would be unable to purchase products or services through use of the token. The user profile would indicate that the customer is not a member of the country club and therefore unable to participate in country club activities or to purchase country club products.

In accessing the computer system 314, from a POS computer 306, the manager module 330 and GUI 328 may prompt for a login or other user identification. The system computer 314 may be configured to establish user accounts with user names and passwords. The user accounts may correspond to a customer or a service provider acting on a user's behalf. If the user account corresponds to a user, the user account may be associated with the user profile 325 stored in the database 324. Thus, when logging in, the system computer 314 is able to retrieve the user profile 325. A user profile 325 may indicate a certain membership or privilege that allows for incentives, such as benefits and discounts. For example, a user may have membership in a resort incentive program, frequent flyer program, dining club, country club, travel lounge, and the like. In generating a token 302, the token module 322 may apply token rules 334 to ensure that incentives, benefits, and discounts will be accrued, recognized, and attributed as appropriate for token-based transactions.

A user or service provider operates the POS computer 306 to access a user account, create a user account, or enter credentials that will entitle the user to a token. The POS computer 306 and the system computer 314 may operate to confirm a user's identity and confirm revenue sources based on entered user information. The POS computer 306 and the system computer 314 may operate collaboratively to generate a token based on one or more revenue sources associated with a user. Confirmation and token generation may involve having the system computer 314 access a user account and access external databases and servers to confirm user revenue sources and couple a token 302 to user revenue sources. Thus, the token modules 312, 322, collectively, or even independently, confirm at least one user's identity and couple that user's identity to at least one confirmed revenue source.

Once token generation is authorized, a physical embodiment of the token 302 may be created. The POS computer 304 may be in electrical communication with any number of apparatuses known in the art to generate a unique token 302. For example, a device may stamp or otherwise dispose a machine readable code on a generic wristband to thereby create a unique wristband corresponding only to one user and associated revenue sources. As can be appreciated, a variety of tokens 302 may be generated in this manner. The token 302 may then be manually delivered to the uniquely identified user. In one embodiment, a token 302 may be immediately fitted or attached to a user. For example, a token 302 configured as a wristband may be fitted onto a user manually or through use of a mechanical device. If a device for generating a token 302 is not within the vicinity of the POS computer 304, the user may be directed to the appropriate location to obtain the token 302.

The system computer 314 may be in electrical communication with one or more vendor POS computers 340 through a computer network 316, PSTN, or the like. Each vendor POS computer 340 is enabled to transact for goods and services through use of a token 302. A vendor POS computer 340 may be physically located, in whole or in part, at a vendor site where goods and services are provided. To assist in communication with the system computer 314, a vendor POS computer 340 may comprise a plug-in interface module 342. The plug-in interface module 342 bridges communication between different software systems and protocols to enable integration with the system 300 and may comprise any number of hardware and/or software components.

The vendor POS computer 340 may include or be in electrical communication with a token reader 344 which enables machine reading of a token and translation to a computer readable format. Depending on the configuration of a token 302, the token reader 344 may electrically, mechanically, optically, and/or electromagnetically read a token 302. A token reader 344 may comprise a barcode scanner, electromagnetic light sensor, magnetic stripe reader, or any other device known in the art to enable computer or machine reading. When a token 302 is configured as a biometric, the token reader 344 may incorporate any number of known biometric techniques and devices to accurately confirm a user's identity.

A vendor POS computer 340 may not be permitted to incorporate a plug-in interface module 342. This may occur where, for policy reasons, a vendor cannot allow the plug-in interface module 342 to be resident on the vendor POS computer 340. Alternatively, a vendor POS computer 340 may be technically incapable of supporting the plug-in interface module 342. For vendor POS computers 340 that are unable to integrate with the system 300, an integration module 350 may be provided. The integration module 350 may comprise hardware and proprietary firmware to enable integration and communication with the system 300 and the system computer 314.

The integration module 350 may include a token reader 352 to read and identify a token. The integration module 350 may be in electrical communication with the system computer 314 to enable token-based transactions. In operation, the integration module 350 identifies the token 302 either through use of a token reader 352 or through manual entry of a token identification by the vendor. The integration module 350 then performs a token-based transaction by communicating with the system computer 314. The system computer 314 confirms the validity of the token and the available token resource and forwards confirmation to the integration module 350. The integration module 350 may visually display the confirmation, and a transaction for goods and services may be completed. The system computer 314 records the transaction including any monetary amount owed to the vendor. The system computer 314 may reconcile accounts and amounts owed at a later time through batch processing and other means known in the art. In this manner, a user may conduct a token-based transaction with a vendor POS.

The system 300 allows for an open environment in conducting token-based transactions. At many resorts, a room identification may only be used for billing with vendors that are owned and operated by the resort. A vendor operating on-site is frequently incapable of billing a room identification as they are not affiliated with the resort billing system. Vendors operating nearby, but off-site, are incapable of transacting based on a room identification. The system 300 allows for unprecedented convenience in enabling users to freely conduct token-based transactions with participating vendors.

A resort which issues a token has the incentive of providing an attractive convenience to guests. This dramatically differs with dated policies of keeping a guest on-site to restrict guests to transactions only with the resort. However, as competition in the hospitality industry continues to intensify, destinations that increase options rather than limit them will be more successful and attractive to the market.

A participating entity issuing a token, defined herein as a token-issuer, may also receive a commission from participating vendors. Token-based transactions conducted with participating vendors would result in revenues for the token-issuer. Whereas presently a token-issuer receives no compensation for users transacting off-site, a token-issuer would then receive revenue. For example, hotel guests frequently choose to dine off-site and enjoy the change in venue and the variety offered by fine restaurants. A token-issuing hotel is incentivized to direct and recommend guests to participating restaurants. As can be appreciated, the system 300 is not limited to dining establishments, but includes all vendors of goods and services. As hotel guests will inevitably venture off-site for recreation, dining, and other goods and services, the system 300 provides an enhanced guest amenity and a new revenue source.

Referring to FIG. 4, an embodiment of a system 400 for token-based transactions is shown. A POS computer 402 may be configured as a user's personal computer, such as a desktop, laptop, PDA, blackberry, or any other computer device with Internet browsing capability. The POS computer 402 may operate a conventional browser to enable generation of one or more tokens. The user operates the POS computer 402 to enter credentials that will entitle the user to a token, print out a token, receive an electronic token, or enable an existing device to be a token.

The POS computer 402 is in electrical communication with a system computer 404, such as a server, over a computer network 406. The system computer 404 may be embodied similarly to the system computer 314 discussed above. Accordingly, the system computer 404 may include a processor 408, memory or computer readable storage medium 410, network interface 412, token module 414, token rule tables 416, token rules 418, GUI 420, manager module 422, and database 424. These components and modules may operate as described above.

The user enters credentials into the POS computer 402 which will confirm a user's identity and confirm one or more revenue sources. The system computer 404 may verify and confirm the user's identity and the revenue sources by accessing a user's profile and/or accessing external resources. The user may further enter user travel information, such as travel reservation confirmation numbers relating to a resort, airfare, hotel, cruise passage, passage, tour, and the like. The system computer 404 may thereby couple a token to the user, revenue source(s), and travel reservations.

A user may also access the system computer 404 to perform any of the functions discussed in relation to FIGS. 1 and 2. Thus, the system computer 404 may be used to request and view travel options and possible itineraries, schedule travel options, and purchase travel options. The system computer 404 may further be used to plan and schedule a series of events. An individual travel reservation or travel package may be associated with a token. As such, when a user arrives at a travel destination, a unique token may be ready for the user. For example, a user may arrive at a front desk of a hotel and, after confirming a user's identify, the previously generated and created token may be delivered to the user. A token generated in this manner may also be coupled to the user's travel information including accommodations, preferred travel contact information, dates of arrival and departure, schedule of events, event confirmation numbers, airfare confirmation numbers, car rental confirmation numbers, and the like.

The system computer 404 may further initiate a token wizard 460 resident within a memory 406 to customize one or more tokens. The token wizard 460 may generate a user interface to prompt a user for queries regarding token use. Based on the user-entered responses, the token wizard 460 may generate customized token rules which are then applied to one or more tokens.

A user may be prompted for spending limits, venue limits, vendor limits, geographical limits, travel limits, revenue sources, and the like. As discussed above, spending limits may differ for minors or for users who are not responsible for the revenue source. A user may decide to limit a venue or vendor if they are deemed inappropriate. For example, a minor may not be able to use a token in a night club, with vendors serving alcohol, or for adult entertainment. Geographical limits may also be put into effect where users are unlikely to venture beyond a predetermined area. Travel limits may also be placed on tokens to prevent users from using certain travel options, such as a taxi or subway. Revenue sources may also be listed for access priority and also may be available for certain tokens and unavailable for other tokens. Thus, a parent may have unlimited access to all revenue sources, within any associated limits, but a child may only have access to one revenue source.

The token wizard 460 may query a user for initial party information and then generate suggested customized token rules. For example, the token wizard 460 may prompt the user for the number of adults and minors and provide recommended token rules. The recommended token rules may be accepted or modified by the user and then finalized by the system computer 404. The token wizard 460 may also access a user profile to generate recommended token rules and present them to the user for acceptance. If desired, a user may be able to subsequently modify customized token rules. A user may later access the system computer 404 and reconfirm an identity or otherwise log-in and then modify the customized token rules. Alternatively, a user may access the system computer 404 with a participating vendor POS computer. The vendor POS computer may be at a hotel, resort, airport, cruise ship, or the like.

After confirming a user's credentials, a user may obtain a token at an affiliated, sponsored, or otherwise associated site. The system computer 404 may provide the instructions in a rendered webpage or send the instructions by email. A user may then obtain the token by physically traveling to a site, such as a resort, theme park, cruise ship, gate agent, or the like. When a user arrives at a site, the user provides identity confirmation, account confirmation, reservation confirmation or the like and may obtain a token. The user may also establish one or more token rules regarding use. The token rules may determine token-specific spending limits, duration, vendor eligibility, incentives, and the like. Alternatively, or in addition, one or more rules may have been previously established when the user initiates an Internet transaction on the user POS computer 402.

In one embodiment, the system computer 404 may enable a user to print out one or more tokens from a user POS computer 402 in hardcopy form. The printed token may serve as a temporary token until a permanent token is obtained at a site. Thus, a user may travel to a POS site and provide confirmation and obtain a token to replace a hardcopy, print-out token.

The system computer 404 may also email a token to a user. The emailed token may be a barcode or other unique code that may be graphically displayed. For example, the token may downloaded from the user POS computer 402 to a portable, hand-held computer device. The hand-held computer device, such as a cellular telephone, Blackberry, iPhone, PDA, or the like, graphically displays the token for viewing by a token reader or even by a human.

In an alternative embodiment, the system computer 404 may designate an existing user item to be a token. An identification card that uniquely corresponds to a user may be used, such as a driver's license, military identification card, security identification card, and the like. For example, a user's driver's license may be designated as a temporary or permanent token. A user may enter a driver's license number in the user POS computer 402 and transmit the license number to the system computer 404. The token module 414 may then identify and confirm the driver's license number as the token. At a vendor POS, the driver's license may be read by a token reader to identify and confirm the driver's license. A driver's license may be embodied as a magnetic stripe card or as a smart card to enable reading by a suitably configured token reader.

A user's credit card, debit card, or other type of transaction card, collectively referred to herein as a transaction card, may also be embodied as a token. Transaction card information may be received by the system computer 404 which confirms that the transaction card is legitimate and valid. The system computer 404 may access third party resources to confirm a transaction card. The transaction card may then be recognized by the system computer 404 as a token. The transaction card may be uniquely identified through an account number or other unique code. The transaction card may be embodied as a magnetic stripe card or smart card to enable reading by a token reader. In this manner, a user may conveniently use an existing item with which a user is already familiar.

A user's hand-held portable device, such as a cellular telephone, Blackberry, PDA, or the like may also be designated as a token as long as the portable device can be uniquely identified. Bluetooth technology and identification chips allow for unique identification of hand-held portable electronics. Once again, unique information regarding the portable device is transmitted to the system computer 404 which establishes the device as a token.

Although techniques described herein in reference to FIG. 4 contemplate the use of a user POS computer 402, one skilled in the art will appreciate that user information may be conveyed to a system computer 404 through any POS computer, participating terminal, or the like.

In one embodiment, a user's biometric characteristic, such as a physiological characteristic may be identified as a token. These characteristics may include any feature derived from a face, hand, eye, bone, heartbeat, and the like. For further confirmation, a plurality of characteristics may be used as a token. A user's unique biometric characteristics are read by a conventional biometric reader which then generates unique user biometric information. The user biometric information is transmitted to the system computer 404 which identifies and confirms the user biometric characteristic as a token. A token reader at a vendor POS may be embodied as a biometric reader to read a user biometric characteristic. The read biometric characteristic may then be transmitted to the system computer 404 which compares the read biometric characteristic to a stored biometric characteristic.

To enable a transaction, a token is read at a vendor POS having a vendor POS computer 470. The vendor POS computer 470 may be in electrical communication with the system computer 404 through the network 406 to allow token confirmation and monitor transactions. Confirmation includes ensuring that the token corresponds to the user, the monetary amount of the proposed transaction does not exceed a limit for the token, and the token is valid for the POS location.

As discussed above, a token reader 472 may be in electrical communication with the vendor POS computer 470 and used to read a token. In many embodiments, the token may comprise a tangible token object that is easily carried by a user. The token may further comprise a token code that is disposed on or within the token object and is machine or human readable. The token code may be disposed in various ways using conventional optical, electrical, electromagnetic, and mechanical technology. As can be appreciated, machine reading of a token code reduces common human error that is associated with conventional techniques. For example, charging a restaurant bill to a hotel room requires a user to accurately remember and enter a room number. Machine reading may be accomplished through any number of known conventional technologies.

A vendor POS computer 470 may be identified as an on-site vendor, that is, the vendor location is physically on-site with a hotel, theme park, resort, cruise ship, or the like where a user has a reservation. The reservation corresponds to a user's physical stay for a time duration at a site, referred to herein as reservation site or reservation property. The stay may include accommodations, such as a room, suite, cabin, or the like. The stay may also include a tour, passage, or other event which requires the user's presence. An on-site vendor may be owned, affiliated, licensed, or have some relationship with a site owner. For example, an on-site hotel restaurant may be owned by the same entity that owns the hotel, or the on-site hotel restaurant may have a contract to operate on the hotel property. In both situations, the hotel restaurant is considered to be physically on-site.

An off-site vendor is physically located off the reservation property. An off-site vendor may be any vendor offering goods or services and may or may not be owned by or affiliated with the owner of the reservation property. An off-site vendor would be outside a hotel property, a theme park, or cruise ship holding a user's reservation. An off-site vendor may nevertheless be a participant in the system 400 and be enabled for token-based transactions. An on-site vendor may install a vendor POS computer 470 with a token reader 472, or an integration module as discussed above. The POS computer 470, whether on-site or off-site, is fully capable of conducting token-based transactions. A user may then transact with all participating vendors using only a token. In one example, a user may use a token throughout a resort where a user is staying and also use the token at participating off-site vendors who are adjacent the resort.

A reservation property may be encouraged to participate in the system 400 by receiving a percentage of all token-based transactions conducted off-site. Rather than encouraging guests to stay on-site for transactions, a reservation property may welcome guests to go off-site. The reservation property further enjoys the added amenity of provided the token-based convenience to guests. Off-site vendors benefit from the potential of increased business through participation. Furthermore, a variety of incentive, promotion, and discount programs may be derived for users and between vendors to encourage participation.

Referring to FIG. 5, a flow diagram of a process 500 for generating a token by a system computer is shown. The process 500 may be used to generate a single token or multiple tokens for an associated travel party. A computer system, or central token server, receives 502 user information corresponding to the user and a user identity. The user information may include a name, username, password, financial account information, biometric information, and the like.

The computer system further receives 504 revenue source information corresponding to the user and a revenue source. As discussed above, the revenue source may be a bank account, money market account, credit account, debit account, incentive rewards account, room or cabin account, or the like.

The computer system receives 506 reservation information including a reservation corresponding to the user for a time period at a physical property site, such as a reservation property which may also be the token issuer. The reservation information may include the number of guests, length of stay, type of accommodations, and other relevant information. The reservation information may include a room or cabin number which may also serve, in part, as the revenue source information. In addition to the room or cabin number, revenue source information may also include a monetary account that supports the reservation.

The computer system receiving the reservation information may also include generating the reservation information at approximately the same time that a token is generated or issued. Thus, a customer may arrive at reservation property without a reservation and corresponding reservation information. A reservation and reservation information may be generated substantially simultaneously with token generation and issuance. The reservation information includes a time period for the user/customer at the reservation property and the token may be valid during the prescribed time period. By way of example, a customer may arrive at a theme park, purchase a one day pass, and receive a token valid for the day. The reservation information would correspond to the theme park, which is the reservation property, and would include a time period of one day. As defined herein, reservation information comprises information corresponding to a user's entitled time period of stay at a reservation property.

The user, revenue source, and reservation information may be, in whole or in part, transmitted through use of a remote personal computer accessing a website, a call center, a concierge, or a wireless device. The computer system may also access and receive information from an internal or external server or database based on a portion of information. For example, the computer system may receive user information and be able to retrieve and receive corresponding revenue source information and/or reservation information. In generating a token, a computer system may have access to a plurality of revenue sources and a user may be prompted to select a revenue source and even prioritize revenue sources.

The computer system links 508 the user information, the revenue source information, and the reservation information. The computer system is thereby able to generate 510 a token code uniquely corresponding to the user and associated with the revenue source information and the reservation information.

The computer system may also generate 512 token rules associated with a token. The token rules determine when tokens may be enabled for vendor POS locations. The token rules may include a total charge limit for token-based transactions. A total charge limit is the total monetary amount that may be charged to a single token, or plurality of tokens, for the entire reservation. The token rules may include a limit on the type of POS locations available for token-based transactions. The token rules may also include a geographical limit on the POS locations available for token-based transactions. The token rules may also include a time charge limit corresponding to a predetermined amount of time. As discussed above, the token rules may vary between different tokens in the same party.

The computer system may electronically transmit 514 the token code to a token generation device to dispose the token code on a tangible token object. The token code may be sent to any facility, instrument, or device to create a tangible token.

The computer system enables 516 use of the token to conduct transactions for the reservation time period at all participating point-of-sale locations. The computer system allocates the appropriate charge for each transaction to the corresponding revenue source. The computer system may also disable 518 the token at the end of the appropriate time period. The end of the time period may be the end of a reservation or upon check-out from a reservation property.

It will be obvious to those having skill in the art that many changes may be made to the details of the above-described embodiments without departing from the underlying principles. Therefore, the scope should be determined only by the following claims.

1. A computer-implemented method for creating a token to enable a user to conduct token-based transactions, comprising:
a computer system receiving user information corresponding to the user and a user identity;
the computer system receiving revenue source information corresponding to the user and a revenue source;
the computer system receiving reservation information including a reservation corresponding to the user for a time period at a reservation property corresponding to the reservation for the user;
the computer system generating a token code uniquely corresponding to the user and associated with the revenue source information and the reservation information;
providing a tangible token object;
creating a token by disposing the token code on the token object; and
the computer system enabling use of the token to conduct transactions for the time period at a plurality of point-of-sale locations participating with the computer system including point-of-sale locations at the reservation property and point-of-sale locations off-site from the reservation property to thereby charge a cost to the revenue source at one of the point-of-sale locations.

2. The method of claim 1, wherein the off-site point-of-sale locations are unassociated with an owner of the reservation property.

3. The method of claim 1, wherein the computer system receiving user information comprises receiving the user information from a remote personal computer accessing a website.

4. The method of claim 1, wherein the computer system receiving user information comprises receiving the user information from a call center.

5. The method of claim 1, wherein the computer system receiving user information comprises receiving the user information from a concierge.

6. The method of claim 1, wherein the computer system receiving user information comprises receiving the user information from a wireless device.

7. The method of claim 1, further comprising the computer system generating a plurality of token rules associated with the token, the token rules determinative of token enablement in a token-based transaction.

8. The method of claim 7, wherein the token rules include a total charge limit for token-based transactions.

9. The method of claim 7, wherein the token rules include a limit on the type of point-of-sale locations available for token-based transactions.

10. The method of claim 7, wherein the token rules include a geographical limit on the point-of-sale locations available for token-based transactions.

11. The method of claim 7, wherein the token rules include a time charge limit corresponding to a predetermined amount of time.

12. The method of claim 7, wherein the computer system generating a plurality of token rules includes enabling the user to customize the token rules based on user-entered input.

13. The method of claim 12, wherein the computer system generating a plurality of token rules includes providing a token rules wizard to a user on a remote computer to thereby allow the user to customize the token rules based on user-entered input.

14. The method of claim 1, wherein creating a token by disposing the token code on the tangible token object includes,
the computer system transmitting the token code to a user operated remote computer; and
the remote computer printing the token code onto the token object.

15. The method of claim 14, further comprising the computer system generating a replacement token based on the user information, the revenue source information, and the reservation information, the replacement token uniquely corresponding to the user.

16. The method of claim 1, wherein the token code is embodied as computer displayable graphic and the token object is embodied as a portable, hand-held electronic device and wherein creating the token includes storing the computer displayable graphic on the portable, hand-held electronic device.

17. The method of claim 1, further comprising:
the computer system receiving revenue source information corresponding to the user and a plurality of revenue sources, and wherein the token is associated with the plurality of revenue sources; and
conducting a transaction at one of the plurality of point-of-sale location to charge a cost to one of the plurality of revenue sources.

18. A computer readable storage medium comprising computer readable instruction code for performing a computer-implemented method for creating a token to enable a user to conduct token-based transactions, the method comprising:
operating a computer system to receive user information corresponding to the user and a user identity;
operating the computer system to receive revenue source information corresponding to the user;
operating the computer system to receive reservation information including a reservation corresponding to the user for a time period at a reservation property corresponding to the reservation for the user;
operating the computer system to generate a token code uniquely corresponding to the user and associated with the revenue source information and the reservation information, the token code configured to be disposed on a tangible token object to thereby create a token; and
operating the computer system to enable use of the token to conduct transactions for the time period at a plurality of point-of-sale locations participating with the computer system including point-of-sale locations at the reservation property and point-of-sale locations off-site from the reservation property to thereby enable a transaction at one of the plurality of point-of-sale locations and charging to the revenue source.

19. The computer readable storage medium of claim 18, wherein the off-site point-of-sale locations are unassociated with an owner of the reservation property.

20. The computer readable storage medium of claim 18, wherein operating the computer system to receive user information comprises receiving the user information from a remote personal computer accessing a website.

21. The computer readable storage medium of claim 18, wherein operating the computer system to receive user information comprises receiving the user information from a call center.

22. The computer readable storage medium of claim 18, wherein operating the computer system to receive user information comprises receiving the user information from a concierge.

23. The computer readable storage medium of claim 18, wherein operating the computer system to receive user information comprises receiving the user information from a wireless device.

24. The computer readable storage medium of claim 18, wherein the method further comprises operating the computer system to generate a plurality of token rules associated with the token, the token rules determinative of token enablement in a token-based transaction.

25. The computer readable storage medium of claim 24, wherein the token rules include a total charge limit for token-based transactions.

26. The computer readable storage medium of claim 24, wherein the token rules include a limit on the type of point-of-sale locations available for token-based transactions.

27. The computer readable storage medium of claim 24, wherein the token rules include a geographical limit on the point-of-sale locations available for token-based transactions.

28. The computer readable storage medium of claim 24, wherein the token rules include a time charge limit corresponding to a predetermined amount of time.

29. The computer readable storage medium of claim 24, wherein operating the computer system to generate a plurality of token rules includes enabling the user to customize the token rules based on user-entered input.

30. The computer readable storage medium of claim 29, wherein operating the computer system to generate a plurality of token rules includes providing a token rules wizard to a user on a remote computer to thereby allow the user to customize the token rules based on user-entered input.

31. The computer readable storage medium of claim 18 wherein the method further comprises operating the computer system to transmit the token code to a user operated remote computer.

32. The computer readable storage medium of claim 31, wherein the method further comprises operating the computer system to generate a replacement token based on the user information, the revenue source information, and the reservation information, the replacement token uniquely corresponding to the user.

33. The computer readable storage medium of claim 18, wherein the token code is embodied as a computer displayable graphic and the token object is embodied as a portable, hand-held electronic device and wherein the method further comprises operating the computer system to transmit the computer displayable graphic to the portable, hand-held electronic device.

34. A token transaction computer system to enable creation of tokens and token-based transactions, comprising:
a central token server, including,
a processer, and
a memory in electrical communication with the processor and comprising computer readable instruction code including a token module configured to,
receive user information corresponding to the user and a user identity, revenue source information corresponding to the user and a revenue source, and reservation information including a reservation corresponding to the user for a time period at a reservation property having the reservation,
the token module further configured to generate a token code uniquely corresponding to the user and associated with the revenue source information and the reservation information, and
the token module further configured to generate a token code to be disposed on a tangible token object to enable use of a token to conduct transactions, the token code enabled for transactions for the time period at a plurality of point-of-sale locations participating with the computer system including point-of-sale locations at the reservation property and point-of-sale locations off-site from the reservation property to thereby charge a cost to the revenue source at one of the point-of-sale locations.

35. The computer system of claim 34, wherein the off-site point-of-sale locations are unassociated with an owner of the reservation property.

36. The computer system of claim 34, further comprising a remote computer in electrical communication with the central token server, the remote computer configured to receive user entered user information and transmit the user information to the central token server.

37. The computer system of claim 36, wherein the remote computer is further configured to receive the token code from the central token server and configured to enable printing of the token code.

38. The computer system of claim 34, wherein the computer readable instruction code further comprises a token rules module configured to generate a plurality of token rules associated with the token, the token rules determinative of token enablement in a token-based transaction.

39. The computer system of claim 38, wherein the token rules include a total charge limit for token-based transactions.

40. The computer system of claim 38, wherein the token rules include a limit on the type of point-of-sale locations available for token-based transactions.

41. The computer system of claim 38, wherein the token rules include a geographical limit on the point-of-sale locations available for token-based transactions.

42. The computer system of claim 38, wherein the token rules include a time charge limit corresponding to a predetermined amount of time.

43. The computer system of claim 38, wherein the token rules module is configured to allow user customization of the token rules based on user-entered input.

44. The computer system of claim 38, wherein the token rules module comprises a token rules wizard to enable a user to customize the token rules based on user-entered input.

45. A computer-implemented method for creating a biometric characteristic token to enable a user to conduct token based transactions, comprising:
a computer system receiving biometric user information uniquely corresponding to a user;
the computer system receiving revenue source information;
the computer system receiving reservation information including a reservation for a time period at a reservation property having the reservation;
the computer system identifying the biometric user information as a token for token-based transactions and linking the token to the revenue source information and the reservation information; and
the computer system enabling use of the token to conduct transactions for the time period at a plurality of point-of-sale locations participating with the computer system including point-of-sale locations on the reservation property and point-of-sale locations off-site from the reservation property.

46. A computer-implemented method for creating a token to enable a user to conduct token based transactions, comprising:
a computer system receiving transaction card information uniquely corresponding to a user;
the computer system receiving revenue source information;
the computer system receiving reservation information including a reservation for a time period at a reservation property having the user reservation;
the computer system identifying a transaction card corresponding to the transaction card information as a token for token-based transactions and linking the token to the revenue source information and the reservation information; and
the computer system enabling use of the token to conduct transactions for the time period at a plurality of point-of-sale locations participating with the computer system including point-of-sale locations on the reservation property and point-of-sale locations off-site from the reservation property.

47. A computer-implemented method for creating a token to enable a user to conduct token based transactions, comprising:
a computer system receiving identification card information uniquely corresponding to a user;
the computer system receiving revenue source information;
the computer system receiving reservation information including a reservation for a time period at a reservation property having the reservation;
the computer system identifying an identification card corresponding to the identification card information as a token for token-based transactions and linking the token to the revenue source information and the reservation information; and
the computer system enabling use of the token to conduct transactions for the time period at a plurality of point-of-sale locations participating with the computer system including point-of-sale locations on the reservation property and point-of-sale locations off-site from the reservation property.
